(19) United States
(12) Patent Application Publication
(10) Pub. No.: US 2025/0313268 A1
(43) Pub. Date: Oct. 9, 2025

(54) ELECTRIC VEHICLE BATTERY PROTECTION FROM SIDE IMPACTS

(71) Applicant: Fisker Inc., Manhattan Beach, CA (US)

(72) Inventors: Umachandran Muralidharan, Manhattan Beach, CA (US); Anthony Bray-Cotton, Manhattan Beach, CA (US); Dhruv Parmar, Manhattan Beach, CA (US)

(21) Appl. No.: 18/628,473

(22) Filed: Apr. 5, 2024

(51) Int. Cl. B62D 21/15; B60K 1/04

(52) U.S. Cl. CPC B62D 21/157; B60K 1/04; B60K 2001/0438

(57) ABSTRACT

The technology disclosed herein enables protection of an electric vehicle battery from side impact forces to the vehicle. In a particular example, an apparatus includes a side sill reinforcement, including an inner wall and an outer wall, and a plurality of reinforcement members running a length of the side sill reinforcement. Strengths of the plurality of reinforcement members differ to direct impact energy around a portion of the vehicle running parallel to the side sill reinforcement when the outer wall is impacted.

### BACKGROUND

A paradigm shift in vehicle design and construction occurred when traditional body-on-frame architectures, once prevalent, are now giving way to unibody structures. Unibody construction integrates the vehicle's body and frame into a single, cohesive structure. Unlike body-on-frame designs, which consist of a separate ladder-like frame and body panels, unibody vehicles rely on a unified framework. Some key advantages of unibody architectures include weight reduction, enhanced safety, improved ride quality, and space optimization. Unibody designs are inherently lighter than body-on-frame counterparts. By eliminating the heavy frame, manufacturers achieve weight savings, leading to improved efficiency and handling dynamics. Unibody vehicles further distribute crash forces across the entire structure, reducing the risk of cabin deformation during collisions. Rigidity and energy absorption are superior, enhancing occupant safety. The absence of frame joints minimizes vibrations and noise, resulting in a smoother ride. Unibody vehicles exhibit better torsional stiffness, contributing to precise handling. Unibody platforms also allow for creative interior layouts, maximizing passenger and cargo space.

Unlike vehicles powered by internal combustion, electric vehicle batteries typically need to be meticulously safeguarded in the event of a side impact due to their vulnerability to physical damage. Electric vehicles rely on large battery packs located within the vehicle's undercarriage or along the vehicle's floor. These battery packs contain numerous individual cells, commonly lithium-ion, that store energy to power the vehicle. A side impact collision can potentially rupture these battery cells, leading to leakage of toxic chemicals, thermal runaway, and ultimately, fires or explosions. For example, in a side impact scenario, the rapid deformation of the vehicle's structure can directly impact the battery pack, causing internal damage that may lead to thermal runaway. Therefore, it is essential for modern unibody structures to mitigate the risks associated with side impacts and ensure the integrity of electric vehicle batteries.

### SUMMARY

The technology disclosed herein enables protection of an electric vehicle battery from side impact forces using side sill reinforcement extrusions. In a particular example, an apparatus includes a side sill reinforcement, including an inner wall and an outer wall, and a plurality of reinforcement members running a length of the side sill reinforcement. Strengths of the plurality of reinforcement members differ to direct impact energy around a portion of the vehicle running parallel to the side sill reinforcement when the outer wall is impacted.

In another example, an apparatus includes a first side sill reinforcement, a second side sill reinforcement positioned on an opposite side of the vehicle from the first side sill reinforcement, and a vehicle crossmember spanning the vehicle between the first side sill reinforcement and the second side sill reinforcement. The vehicle crossmember absorbs impact energy directed into the vehicle crossmember from at least one of the first side sill reinforcement and the second side sill reinforcement.

In a further example, an apparatus includes a left-side sill reinforcement affixed within a left rocker panel of a unibody structure for a vehicle and a right-side sill reinforcement affixed within a right rocker panel of the unibody structure. The apparatus further includes a battery cavity between the left-side sill reinforcement and the right-side sill reinforcement. The apparatus also includes a vehicle crossmember above the battery cavity and affixed to the left-side sill reinforcement at a first end and the right-side sill reinforcement at a second end. The left-side sill reinforcement and the right-side sill reinforcement are formed to direct impact energy into the vehicle crossmember rather than the battery cavity.

### BRIEF DESCRIPTION OF THE DRAWINGS

FIG. 1 illustrates a vehicle having side sill reinforcements that direct impact energy into a vehicle crossmember.

FIG. 2 illustrates a magnified portion of a vehicle having side sill reinforcements that direct impact energy into a vehicle crossmember.

FIG. 3 illustrates a top-down view of a vehicle having side sill reinforcements that direct impact energy into a vehicle crossmember.

FIG. 4 illustrates a cross section of a vehicle having side sill reinforcements that direct impact energy into a vehicle crossmember.

FIG. 5 illustrates a magnified portion of a vehicle having side sill reinforcements that direct impact energy into a vehicle crossmember.

FIG. 6 illustrates a side sill reinforcement for a vehicle that directs impact energy into a vehicle crossmember.

FIG. 7 illustrates a side sill reinforcement for a vehicle that directs impact energy into a vehicle crossmember.

FIG. 8 illustrates a side sill reinforcement for a vehicle that directs impact energy into a vehicle crossmember.

FIG. 9 illustrates cross section of a side sill reinforcement for a vehicle that directs impact energy into a vehicle crossmember.

FIG. 10 illustrates a scenario for a vehicle having side sill reinforcements that direct impact energy into a vehicle crossmember.

FIG. 11 illustrates a scenario for a vehicle having side sill reinforcements that direct impact energy into a vehicle crossmember.

### DETAILED DESCRIPTION

In a vehicles unibody architecture, side sill reinforcements play a critical role in enhancing occupant safety by providing structural reinforcement and energy absorption during collisions. Typically located along the bottom edge, or rocker, of the vehicle's body, these sturdy components serve as a barrier between the vehicle's occupants and external impacts. Side sill reinforcements are designed to distribute forces from a collision along the length of the vehicle, helping to minimize the concentration of energy transferred to the passenger compartment. This dispersion of force helps reduce the risk of intrusion into the cabin area, thereby protecting the occupants from severe injuries. Additionally, side sill reinforcements contribute to the overall rigidity of the vehicle's frame, which enhances stability and structural integrity, especially during side-impact collisions where the risk of intrusion is high. By incorporating robust side sill reinforcements into the unibody architecture, car manufacturers prioritize occupant safety by fortifying the vehicle's structure against various impacts and collisions.

Unlike in electric vehicles where battery packs are commonly located under the vehicle's floor, traditional automobiles do not have to account for the presence of these bulky battery packs. Consequently, the design of side sill reinforcements in traditional cars may not prioritize considerations for protecting the battery pack from impacts. This lack of integration means that, in the event of a collision, there is a heightened risk that impacts to the side sill reinforcements could potentially damage the battery pack, posing safety hazards such as leakage, electrical malfunction, or thermal runaway. The side sill reinforcements and vehicle crossmember described in the examples below enhances the safety benefits of side sill reinforcements to include protection for the battery pack in an electric vehicle.

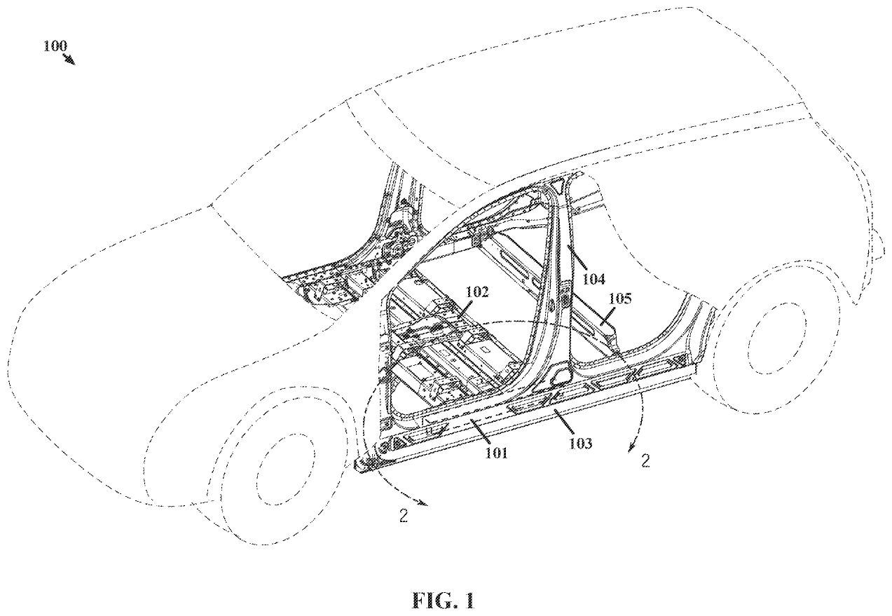

FIG. 1 illustrates vehicle 100 having side sill reinforcements that direct impact energy into a vehicle crossmember. While vehicle 100 is shown as a passenger car or sport utility vehicle (SUV), vehicle 100 may be any type of vehicle that may benefit from side impact protection, such as a truck, van, bus, or other vehicle. Vehicle 100 is a unibody vehicle with rocker 103 and b-pillar 104 forming a portion of the unibody that surrounds the passenger compartment of vehicle 100. The unibody provides structure for the vehicle in place of a traditional frame to which a body mounts. Cosmetic panels, doors, and other vehicle components may be mounted to the unibody to complete vehicle 100 during manufacturing.

In this example, side sill reinforcement 101 is fitted to vehicle 100 behind rocker 103 to provide side impact protection for vehicle 100 beyond what is provided by rocker 103. In some examples, side sill reinforcement 101 may be incorporated into the unibody structure (e.g., by being welded or adhesively bonded to the structure) or may remain a separate component behind the structure. Side sill reinforcement 101 is connected to vehicle crossmember 102, which spans the floor of the interion of vehicle 100 in this example. Vehicle crossmember 102 may provide structural rigidity to vehicle 100 under normal operation but also functions as a component to which energy from a side impact can be directed from side sill reinforcement 101. In this example, vehicle crossmember 102 is wide enough to extend along a substantial portion of side sill reinforcement 101 for effective energy transfer. In some examples, vehicle crossmember 102 may comprise multiple crossmembers spaced out along the length of side sill reinforcement 101. The length and position of side sill reinforcement 101 corresponds roughly to where a passenger sits in the front of vehicle 100. In other examples, side sill reinforcement 101 may be longer, shorter, or positioned differently relative to the passenger compartment of the vehicle (e.g., may extend substantially the entire length between wheel wells). Vehicle crossmember 102 may be different thicknesses or shapes depending on the amount of energy vehicle crossmember 102 is designed to receive prior to bending or breaking, the type of material (e.g., metal type) used to produce vehicle crossmember 102, weight requirements for vehicle 100, or some other characteristic. Vehicle crossmember 102 may be connected to side sill reinforcement 101 via welds, adhesive, rivets, bolts, joints, or some other type of fastener that enables transfer of impact energy between components—including combinations thereof. In some examples, another side sill reinforcement similar to side sill reinforcement 101 may be connected to vehicle crossmember 102 at the opposite side of vehicle 100. Vehicle 100 includes an additional crossmember 105 in this example but, since crossmember 105 is not connected to vehicle crossmember 102, crossmember 105 may be omitted in some examples.

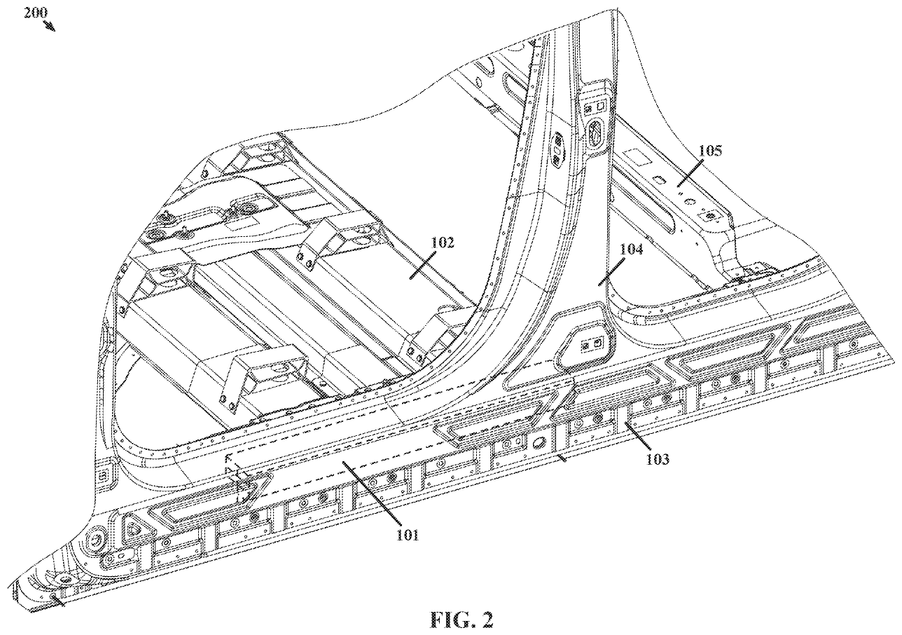

FIG. 2 illustrates magnified portion 200 of vehicle 100 having side sill reinforcements that direct impact energy into a vehicle crossmember. Magnified portion 200 is a zoomed-in version of vehicle 100 from FIG. 1 with side sill reinforcement 101, vehicle crossmember 102, rocker 103, b-pillar 104, and crossmember 105 shown in more detail. In this example, vehicle crossmember 102 also acts as a portion of the passenger floor of vehicle 100. As such, vehicle crossmember 102 includes brackets for mounting seats, consoles, or other interior trim components-including combinations thereof. In other examples, the additional features of vehicle crossmember 102 may be omitted. Likewise, the details of b-pillar 104 and crossmember 105 are merely exemplary and may be different in other examples. Vehicle 100 is an electric vehicle in this example and vehicle crossmember 102 runs along the floor of vehicle 100 above a battery pack for vehicle 100. The battery pack for an electric vehicle is typically a high-voltage (e.g., greater than 300V) battery pack that provides electrical power to run one or more traction motors of the vehicle. Vehicle crossmember 102 is positioned to receive impact energy from side sill reinforcement 101 instead of that energy being received by the battery pack. In other examples, such as those where vehicle 100 is not an electric vehicle or the battery pack is positioned elsewhere, vehicle crossmember 102 may be positioned above a cavity that is filled with something other than a battery pack (e.g., a fuel tank, fuel cell, or some other component in need of side-impact protection).

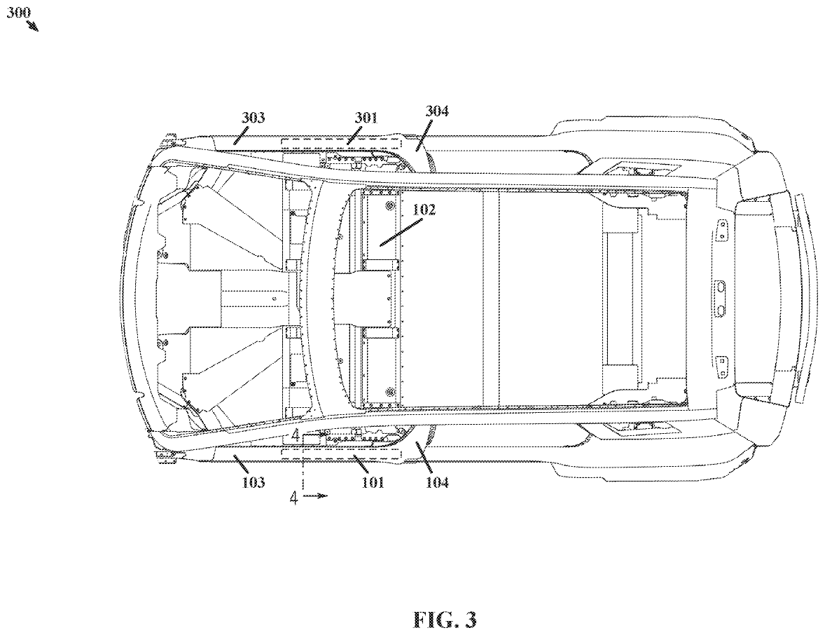

FIG. 3 illustrates top-down view 300 of vehicle 100 having side sill reinforcements that direct impact energy into a vehicle crossmember. From top-down view 300, more of vehicle 100's unibody structure can be seen. Specifically, side sill reinforcement 301 can be seen at the opposite end of vehicle crossmember 102 and may be connected to vehicle crossmember 102 in a similar manner to side sill reinforcement 101. Side sill reinforcement 301 is located on what may be referred to as the right side of vehicle 100 from the perspective of a passenger facing forward therein while side sill reinforcement 101 is on the left side of vehicle 100. In this example, the right side of vehicle 100 is a mirrored version of the left side. As such, the right side includes rocker 303 like rocker 103 and b-pillar 304 like b-pillar 104. In other examples, vehicle 100 may not be symmetrical.

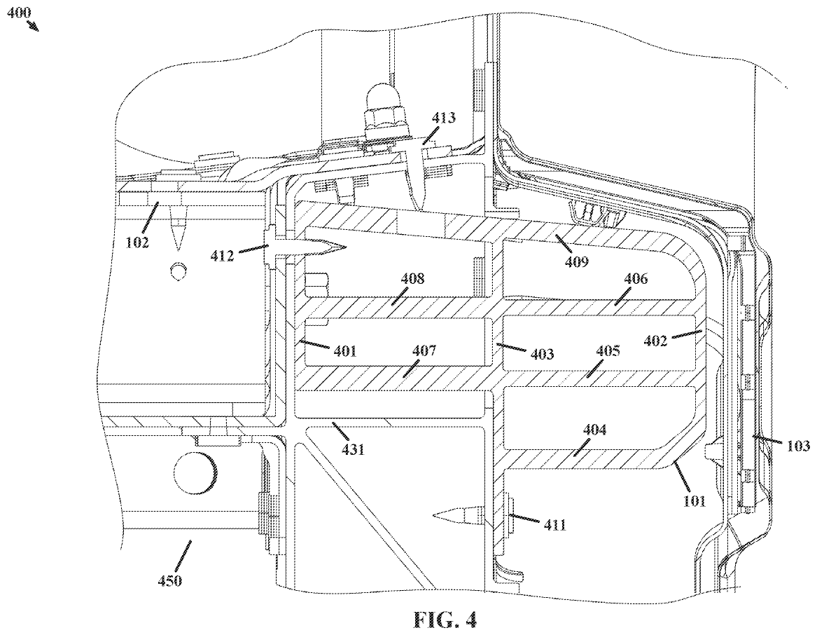

FIG. 4 illustrates cross section 400 of vehicle 100 having side sill reinforcements that direct impact energy into a vehicle crossmember. Cross section 400 enables the interior of side sill reinforcement 101 to be viewed. In this example, side sill reinforcement 101 includes inner wall 401 and outer wall 402 connected by reinforcement members 404-409. In this example, side sill reinforcement 101 includes interior wall 403 between inner wall 401 and outer wall 402. Although, in other examples, side sill reinforcement 101 may not include an interior wall or may include multiple interior walls. Reinforcement member 409 and reinforcement member 404 curve into outer wall 402 but may connect with outer wall 402 differently in some other examples. While side sill reinforcement 101 includes interior wall 403 in this example, interior wall 403 may be omitted in other examples allowing reinforcement members to extend from inner wall 401 to outer wall 402 like reinforcement member 409.

Side sill reinforcement 101 is attached via fastener 411 through interior wall 403 into unibody structure 431. Vehicle crossmember 102 is attached via fastener 412 through unibody structure 431 to inner wall 401 and attached via fastener 413 to unibody structure 431. While vehicle crossmember 102 does not contact side sill reinforcement 101 directly in this example, unibody structure 431 should have a negligible effect on energy transfer from side sill reinforcement 101 to vehicle crossmember 102. While side sill reinforcement 101 is shaped as shown in cross section 400 to fit unibody structure 431, side sill reinforcement 101 may take different shapes in other examples with different unibody structure designs. For instance, in another example, reinforcement member 404 may extend all the way to inner wall 401, which may extend below reinforcement member 407 to meet reinforcement member 404. Similarly, the number and arrangement of reinforcement members 404-409 may differ depending on packaging and impact absorption requirements for a particular vehicle.

In this example, a battery pack for vehicle 100 may be located in cavity 450 below vehicle crossmember 102. Once reinforcement member 404, reinforcement member 405, and reinforcement member 409 have collapsed/crushed to interior wall 403 during an impact, reinforcement member 408, reinforcement member 407, and the remainder of reinforcement member 409 is designed to be stronger than the portion of unibody structure 431 to which side sill reinforcement 101 is attached with fastener 411. The energy from the impact is, therefore, transmitted into vehicle crossmember 102 by reinforcement member 407, reinforcement member 408, and the remainder of reinforcement member 409 while unibody structure 431 crushes, which avoids energy being transmitted into cavity 450 and anything located therein (e.g., a battery pack). Likewise, since reinforcement member 404, reinforcement member 405, and the portion of reinforcement member 409 right of interior wall 403 are designed to be lower in strength than reinforcement member 407, reinforcement member 408, and the portion of reinforcement member 409 left of interior wall 403, interior wall 403 receives impact forces and transmits the forces to reinforcement member 407, reinforcement member 408, the portion of reinforcement member 409 left of interior wall 403 when outer wall 402 is impacted.

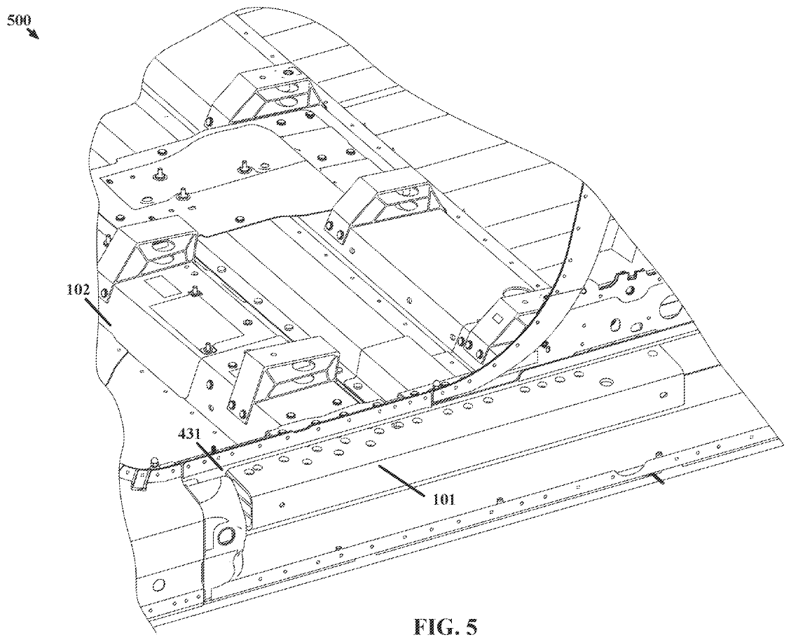

FIG. 5 illustrates magnified portion 500 of vehicle 100 having side sill reinforcements that direct impact energy into a vehicle crossmember. Magnified portion 500 is similar to magnified portion 200 but with rocker 103 and b-pillar 104 omitted to reveal the placement of side sill reinforcement 101 within the unibody structure of vehicle 100. The positioning of unibody structure 431 between vehicle crossmember 102 and side sill reinforcement 101 can also be seen in magnified portion 500.

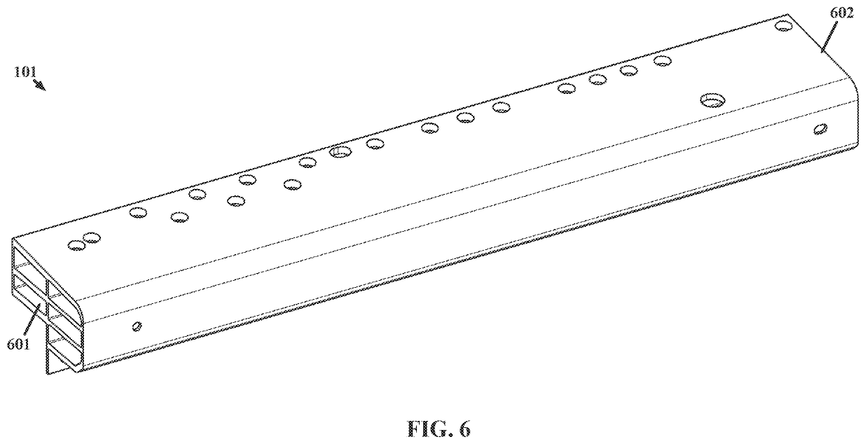

FIG. 6 illustrates side sill reinforcement 101 for vehicle 100 that directs impact energy into a vehicle crossmember. Side sill reinforcement 101 may be mirrored to create side sill reinforcement 301. The entirety of side sill reinforcement 101 is shown from end 601 to end 602. From end 601 all of components 401-409 of side sill reinforcement 101 can be seen extending the same length and components 401-409 also extend to end 602. Although, in other examples, one or more of the components may stop short of end 601 and end 602 (e.g., for packaging reasons within the unibody structure of vehicle 100). Components 401-409 extending the length of side sill reinforcement 101 ensures the impact absorption properties afforded by components 401-409 also extend the length of side sill reinforcement 101. While side sill reinforcement 101 is shown with openings, the openings may be different or omitted in other examples. The openings may be used for fasteners, cable routing, drainage, or for some other purpose.

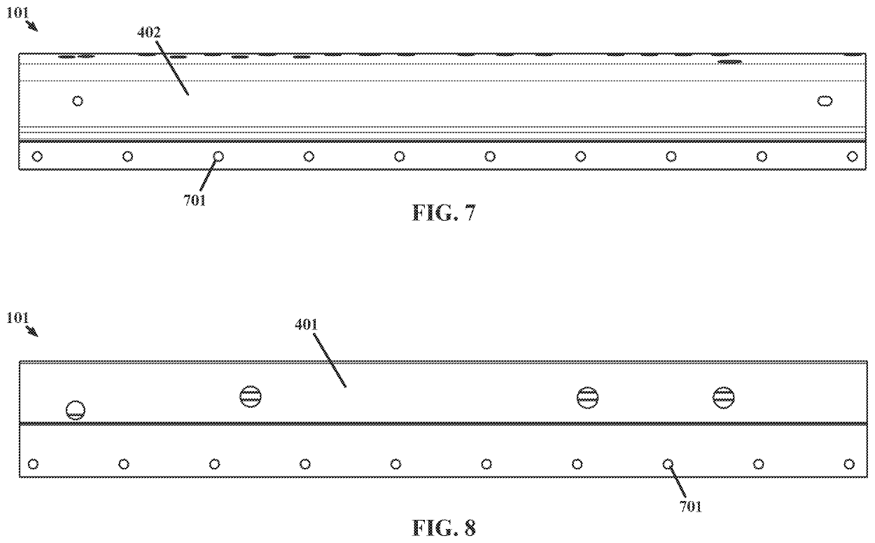

FIG. 7 illustrates side sill reinforcement 101 for vehicle 100 that directs impact energy into a vehicle crossmember. Side sill reinforcement 101 in this example is shown from the perspective looking directly at outer wall 402. Hole 701 is one of ten holes in interior wall 403 through which fasteners connect side sill reinforcement 101 to unibody structure 431. Fastener 411 is an example of one of those fasteners. In other examples, a different type of connection, such as welding, and the holes may be omitted in those examples.

FIG. 8 illustrates side sill reinforcement 101 for vehicle 100 that directs impact energy into a vehicle crossmember. Side sill reinforcement 101 in this example is shown from the perspective looking directly at inner wall 401. The fastener holes, including hole 701, can also be seen.

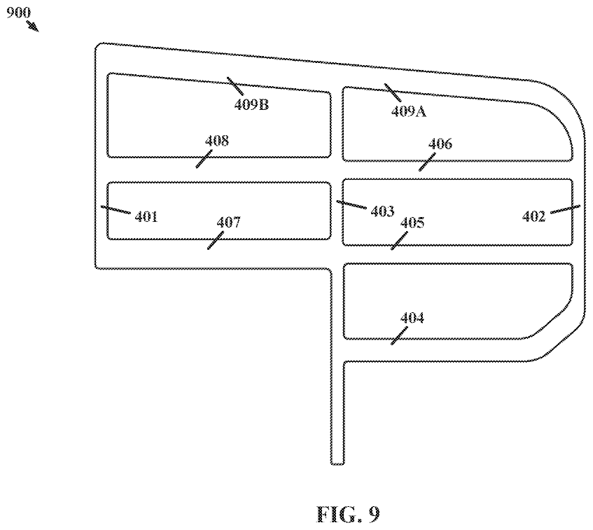

FIG. 9 illustrates cross section 900 of side sill reinforcement 101 for a vehicle that directs impact energy into a vehicle crossmember. Cross section 900 includes components 401-409 just like the cross section of side sill reinforcement 101 in cross section 400. For clarity, reinforcement member 409 is separated into reinforcement member 409A on the right side of interior wall 403 and reinforcement member 409B on the left side of interior wall 403. The different thicknesses of components 401-409 are intentional to vary the strength of the different components while using the same material (e.g., aluminum). Reinforcement member 409A and reinforcement member 407 are the thickest components followed by reinforcement member 408. Reinforcement member 409B and reinforcement member 404 are next thickest followed by reinforcement member 406 and reinforcement member 405. Reinforcement member 404 and reinforcement member 409A taper in thickness into outer wall 402, which is the thinnest component along with interior wall 403 and inner wall 401. For context, the thickest components may be 7.1 millimeters thick, and the thinnest components may be 3 millimeters thick. Other examples may differ the strength of components 401-409 in other ways. For instance, different components may be made out of different strength materials (e.g., steel vs. aluminum) or different components may be formed differently (e.g., one component may be honeycombed while another is solid). Combinations of the above examples may also be used.

Components like side sill reinforcement 101, side sill reinforcement 301, and vehicle crossmember 102 are often referred to as extrusions because of the process used to produce the components. The extrusion process is a manufacturing technique utilized to create metal components with consistent cross-sectional profiles. It involves forcing a metal billet or slug through a die under high pressure, resulting in the desired shape emerging on the other side. Extrusion enables the production of long lengths of uniform sections, reducing the need for secondary machining operations and minimizing material waste. The extrusion process may be preferred for manufacturing side sill reinforcement 101 because side sill reinforcement 101 is a relatively long part and the die can ensure components 401-409 maintain their desired thicknesses the entire length of side sill reinforcement 101. Other manners of manufacturing side sill reinforcement 101, side sill reinforcement 301, and side sill reinforcement 301 may be used instead. For instance, components 401-409 may be produced individually and welded or otherwise adhered together to form side sill reinforcement 101.

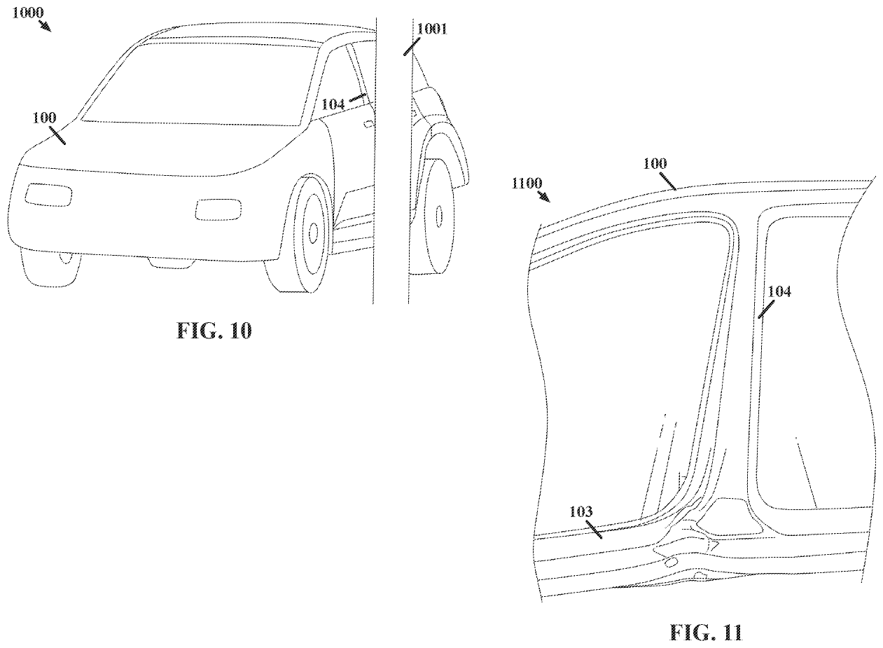

FIG. 10 illustrates scenario 1000 for vehicle 100 having side sill reinforcements that direct impact energy into a vehicle crossmember. Scenario 1000 is an example side impact during which side sill reinforcement 101 is intended to protect a battery pack of vehicle 100. In this case, vehicle 100 impacts pole 1001 just in front of b-pillar 104.

FIG. 11 illustrates scenario 1100 for vehicle 100 having side sill reinforcements that direct impact energy into a vehicle crossmember. Scenario 1100 is an example of the aftermath from the side impact in scenario 1000. Pole 1001 caused an impression in rocker 103 and part way up b-pillar 104. Under rocker 103 components 401-409 of side sill reinforcement 101 absorbed the impact energy and directed the energy to vehicle crossmember 102 to prevent the energy from damaging the battery pack of vehicle 100.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. An apparatus for side impact structure for a vehicle, the apparatus comprising:
a side sill reinforcement including an inner wall and an outer wall;
a plurality of reinforcement members running a length of the side sill reinforcement, wherein strengths of the plurality of reinforcement members differ to direct impact energy around a portion of the vehicle running parallel to the side sill reinforcement when the outer wall is impacted.

2. The apparatus of claim 1, wherein the strengths differ based on thickness of the plurality of reinforcement members.

3. The apparatus of claim 1, wherein the strengths differ based on material used for different ones of the plurality of reinforcement members.

4. The apparatus of claim 1, wherein the plurality of reinforcement members extend from the inner wall to the outer wall.

5. The apparatus of claim 1, wherein:
the side sill reinforcement includes an interior wall positioned between the inner wall and the outer wall, wherein at least a portion of the plurality of reinforcement members extend between the inner wall and the interior wall and at least another portion extend between the interior wall and the outer wall.

6. The apparatus of claim 1, wherein the side sill reinforcement runs along a side of a battery pack for the vehicle and wherein the strengths direct the impact energy over the battery pack.

7. The apparatus of claim 1, wherein the impact energy is directed to a vehicle crossmember of the vehicle.

8. The apparatus of claim 7, wherein the vehicle crossmember extends from the side sill reinforcement to another side sill reinforcement on an opposite side of the vehicle.

9. The apparatus of claim 1, wherein the side sill reinforcement and the plurality of reinforcement members comprise a single extruded metal component.

10. The apparatus of claim 1, wherein the plurality of reinforcement members, the inner wall, and the outer wall are welded or adhesively connected to each other.

11. An apparatus for side impact structure for a vehicle, the apparatus comprising:
a first side sill reinforcement;
a second side sill reinforcement positioned on an opposite side of the vehicle from the first side sill reinforcement;
a vehicle crossmember spanning the vehicle between the first side sill reinforcement and the second side sill reinforcement, wherein the vehicle crossmember absorbs impact energy directed into the vehicle crossmember from at least one of the first side sill reinforcement and the second side sill reinforcement.

12. The apparatus of claim 11, wherein the vehicle crossmember is positioned above a cavity of the vehicle, the first side sill reinforcement is positioned on one side of the cavity, and the second side sill reinforcement is positioned on an opposite side of the cavity from the first side sill reinforcement.

13. The apparatus of claim 12, wherein the cavity is filled with battery cells.

14. The apparatus of claim 12, wherein the impact energy is directed to the vehicle crossmember rather than the cavity.

15. The apparatus of claim 11, wherein first side sill reinforcement and the second side sill reinforcement include reinforcement members running lengthwise internally and wherein the reinforcement members differ in strength to direct the impact energy.

16. The apparatus of claim 15, wherein thicker ones of the reinforcement members are stronger than thinner ones of the reinforcement members.

17. The apparatus of claim 15, wherein the reinforcement members are stronger closer to the vehicle crossmember.

18. An apparatus for a unibody structure of a battery-electric vehicle, the apparatus comprising:
a left-side sill reinforcement affixed within a left rocker panel of the unibody structure;
a right-side sill reinforcement affixed within a right rocker panel of the unibody structure;
a battery cavity between the left-side sill reinforcement and the right-side sill reinforcement; and
a vehicle crossmember above the battery cavity and affixed to the left-side sill reinforcement at a first end and the right-side sill reinforcement at a second end, wherein the left-side sill reinforcement and the right-side sill reinforcement are formed to direct impact energy into the vehicle crossmember rather than the battery cavity.

19. The apparatus of claim 18, comprising:
battery modules within the battery cavity, wherein the battery modules include battery cells for powering the battery-electric vehicle.

20. The apparatus of claim 18, wherein portions of the left-side sill reinforcement and right-side sill reinforcement closer to the battery cavity resist impact energy greater than portions farther from the battery cavity.
